(19) United States
(12) Patent Application Publication
(10) Pub. No.: US 2013/0325458 A1
(43) Pub. Date: Dec. 5, 2013

(54) DYNAMIC MICROPHONE SIGNAL MIXER

(71) Applicants: Markus Buck, Biberach (DE); Timo Matheja, Ulm (DE); Achim Eichentopf, Bad Soden (DE)

(72) Inventors: Markus Buck, Biberach (DE); Timo Matheja, Ulm (DE); Achim Eichentopf, Bad Soden (DE)

(21) Appl. No.: 13/990,176

(22) PCT Filed: Nov. 29, 2010
(86) PCT No.: PCT/US10/58168

§ 371 Date: Aug. 1, 2013

(51) Int. Cl. G10L 21/0208

(52) U.S. Cl. CPC G10L 21/0208
USPC 704/226

(57) ABSTRACT

A system and method of signal combining that supports different speakers in a noisy environment is provided. Particularly for deviations in the noise characteristics among the channels, various embodiments ensure a smooth transition of the background noise at speaker changes. A modified noise reduction (NR) may achieve equivalent background noise characteristics for all channels by applying a dynamic, channel specific, and frequency dependent maximum attenuation. The reference characteristics for adjusting the background noise may be specified by the dominant speaker channel. In various embodiments, an automatic gain control (AGC) with a dynamic target level may ensure similar speech signal levels in all channels.

### TECHNICAL FIELD

The present invention relates to a system and method for a dynamic signal mixer, and more particularly, to a dynamic microphone signal mixer that includes spectral preprocessing to compensate for different speech levels and/or for different background noise.

### BACKGROUND ART

In digital signal processing many multi-microphone arrangements exist where two or more microphone signals have to be combined. Applications may vary, for example, from live mixing scenarios associated with teleconferencing to hands free telephony in a car environment. The signal quality may differ strongly among the various speaker channels depending on the microphone position, the microphone type, the kind of background noise and the speaker himself. For example, consider a hands-free telephony system that includes multiple speakers in a car. Each speaker has a dedicated microphone capable of capturing speech. Due to different influencing factors like an open window, background noise can vary strongly if the microphone signals are compared among each other. Noise jumps and/or different coloration may be noticeable if hard switching between active speakers is done, or soft mixing functions include the higher noise level and increase the resulting noise level.

An automatic microphone mixer concept is proposed in D. Dugan: Application of Automatic Mixing Techniques to Audio Consoles, SMPTE Television Conference, vol. 101, 19-27, New York, N.Y., 1992, which is hereby incorporated herein by reference in its entirety, that uses “automatic mixing” functions for a multi microphone live sound scenario. However, effects from background noise are not considered in Dugan. In S. P. Chandra, K. M. Senthil, M. P. P. Bala: Audio Mixer for Multi-party Conferencing in VoIP, Proceedings of the 3rd IEEE International Conference on Internet Multimedia Services Architecture and Applications (IMSAA'09), 31-36, IEEE Press, Piscataway, N.J., USA, 2009, which is hereby incorporated by reference in its entirety, a noise reduction with a fixed scheme in each channel is disclosed for switching noisy signals, but for the mixer criterion itself the noise is not considered. Other solutions are based on the maximization of the signal-to-noise ratio (SNR) at the output of the mixing process (see, for example: J. Freudenberger, S. Stenzel, B. Venditti: Spectral Combining for Microphonediversity Systems, 17th European Signal Processing Conference (EUSIPCO-2009), Glasgow, 2009; and W. Kellermann: Sprachverarbeitungseinrichtung, (DE 4330243), 1995, both of which are hereby incorporated by reference in their entirety). High background noise scenarios like in a car environment are taken into account, but only one speaker with multiple dedicated microphones is considered. In Freudenberger, a diversity technique is disclosed that assumes similar noise levels in all microphone channels but adds the signals in phase. Another method for using diversity effects and handling different noises is disclosed in T. Gerkmann and R. Martin, “Soft decision combining for dual channel noise reduction,” in 9. Int. Conference on Spoken Language Processing (Interspeech ICSLP), Pittsburgh, Pa., September 2006, pp. 2134-2137, which is hereby incorporated by reference in its entirety. Here the phase differences are estimated during speech periods.

The above-described approaches do not take into account that different noise levels and colorations may occur and that the switching between the activity of different speakers should not be noticeable considering the background noise. Furthermore, noise level should not be increased by the mixing function.

### SUMMARY OF THE EMBODIMENTS

In accordance with an embodiment of the invention, a signal processing system includes a preprocessing module that receives a plurality of signals and dynamically filters each of the signals according to a noise reduction algorithm creating preprocessed signals having substantially equivalent noise characteristics. A mixer combines at least two of the preprocessed signals.

In accordance with related embodiments of the invention, the signal processing system may include a plurality of microphones that provide the plurality of signals. At least two or more of the microphones are positioned in different passenger compartments of a vehicle, such as a car or boat. In other embodiments, the two or more microphones may be positioned remotely at different locations for a conference call.

In accordance with further related embodiments of the invention, the noise reduction algorithm may drive each of the signals such that their background noise is substantially equivalent as to spectral shape and/or power. The noise reduction algorithm may drive each of the signals such that their signal to noise ratio is substantially equivalent. Each signal may be associated with a channel, wherein the noise reduction algorithm includes determining a dynamic spectral floor for each channel based, at least in part, on a noise power spectral density.

In still further related embodiments of the invention, the preprocessing module may further include a gain control module for dynamically adjusting the signal level of each of the signals. The gain control module may dynamically adjust the signal level of each of the signals to a target level. Each signal may be associated with a channel, wherein the preprocessing module may further include a voice activity detection module that determines a dominance weight for each channel, the gain control module adjusting the signal level of each of the signals based, at least in part, on their associated channel's dominance weight.

In yet further embodiments of the invention, each signal is associated with a channel, wherein the preprocessing module may further include a voice activity detection module that determines a dominance weight for each channel, the noise reduction algorithm creating the preprocessed signals for each channel based, at least in part, on their associated dominance weight. The mixer may further include dynamic weights for weighting the preprocessed signals, the dynamic weights different from the dominance weights associated with the preprocessing module.

In accordance with another embodiment of the invention, a method of signal processing includes receiving a plurality of signals. Each of the signals is dynamically filtered according to a noise reduction algorithm creating preprocessed signals having substantially equivalent noise characteristics. At least two of the preprocessed signals are combined.

In accordance with related embodiments of the invention, the method further includes providing, by a plurality of microphones, the plurality of signals, wherein at least two or more of the microphones are positioned in different passenger compartments of a vehicle. In other embodiments, the two or more microphones are remotely located in different positions for a conference call.

In accordance with related embodiments of the invention, dynamically filtering each of the signals according to a noise reduction algorithm may include driving each of the signals such that their background noise is substantially equivalent as to at least one of spectral shape and/or power. Dynamically filtering each of the signals according to a noise reduction algorithm may include driving each of the signals such that their signal to noise ratio is substantially equivalent. Each signal may be associated with a channel, wherein dynamically filtering each of the signals according to a noise reduction algorithm includes determining a dynamic spectral floor for each channel based, at least in part, on a noise power spectral density.

In accordance with further embodiments of the invention, the method may further include dynamically adjusting the signal level of each of the signals in creating the preprocessed signals. Dynamically adjusting the signal level of each of the signals may include adjusting the signal level of each of the signals to a target level. Each signal may be associated with a channel, wherein the method further includes applying a voice activity detection module that determines a dominance weight for each channel. Dynamically adjusting the signal level of each of the signals in creating the preprocessed signals may include creating the preprocessed signals for each channel based, at least in part, on their associated dominance weight.

In accordance with still further embodiment of the invention, each signal is associated with a channel, wherein the method further includes applying a voice activity detection module that determines a dominance weight for each channel. Dynamically weighting each of the signals according to a noise reduction algorithm creating preprocessed signals may include creating the preprocessed signals for each channel based, at least in part, on their associated dominance weight. Combining at least two of the preprocessed signals may further include using dynamic weighting factors for weighting the preprocessed signals. The dynamic weighting factors associated with combining the preprocessing signals may be different from the dominance weights associated with creating the preprocessed signals.

In accordance with another embodiment of the invention, a computer program product for dynamically combining a plurality of signals is provided. The computer program product includes a computer usable medium having computer readable program code thereon, the computer readable program code including program code. The program code provides for dynamically filtering each of the signals according to a noise reduction algorithm creating preprocessed signals having substantially equivalent noise characteristics. At least two of the preprocessed signals are combined.

In accordance with related embodiments of the invention, the program code for dynamically filtering each of the signals according to a noise reduction algorithm may include program code for driving each of the signals such that their background noise is substantially equivalent as to spectral shape and/or power. Each signal may be associated with a channel, wherein the program code for dynamically filtering each of the signals according to a noise reduction algorithm includes program code for determining a dynamic spectral floor for each channel based, at least in part, on a noise power spectral density.

In accordance with further related embodiments of the invention, the computer program product further includes program code for dynamically adjusting the signal level of each of the signals in creating the preprocessed signals. Each signal may be associated with a channel. The computer program product further includes program code for applying a voice activity detection module that determines a dominance weight for each channel. The program code for dynamically adjusting the signal level of each of the signals in creating the preprocessed signals may include program code for creating the preprocessed signals for each channel based, at least in part, on their associated dominance weight.

In still further related embodiments of the invention, each signal may be associated with a channel, the computer program product further including program code for applying a voice activity detection module that determines a dominance weight for each channel. The program code for dynamically weighting each of the signals according to a noise reduction algorithm creating preprocessed signals may include program code for creating the preprocessed signals for each channel based, at least in part, on their associated dominance weight. The program code for combining at least two of the preprocessed signals may further includes program code that uses dynamic weighting factors for weighting the preprocessed signals. The dynamic weighting factors associated with combining the preprocessing signals may be different from the dominance weights associated with creating the preprocessed signals.

### BRIEF DESCRIPTION OF THE DRAWINGS

The foregoing features of embodiments will be more readily understood by reference to the following detailed description, taken with reference to the accompanying drawings, in which:

FIG. 1 shows a system overview of a signal processing system for dynamic mixing of signals, in accordance with an embodiment of the invention;

FIG. 2(a) shows exemplary counters (with cₘₐₓ=100) associated with various channels, in accordance with an embodiment of the invention. FIG. 2(b) shows the counters mapped to speaker dominance weights gₘ(l) that characterize the dominance of a speaker, in accordance with an embodiment of the invention;

FIG. 3 shows a block diagram of an Automatic Gain Control (AGC), in accordance with an embodiment of the invention;

FIG. 4 shows a block diagram of a Noise Reduction (NR), in accordance with an embodiment of the invention;

FIG. 5(a) shows a processed output signal after inter channel switching (no NR). FIG. 5(b) shows the resulting processed signal with b^{ref}=0.4, in accordance with an embodiment of the invention; and

FIG. 6(a) shows the mean voting results of an evaluation of various mixing system methodologies. FIG. 6(b) shows the rating distribution for the different methods.

### DETAILED DESCRIPTION OF SPECIFIC EMBODIMENTS

In illustrative embodiments of the invention, a new system and method of signal combining that supports different speakers in a noisy environment is provided. Particularly for deviations in the noise characteristics among the channels, various embodiments ensure a smooth transition of the background noise at speaker changes. A modified noise reduction (NR) may achieve equivalent background noise characteristics for all channels by applying a dynamic, channel specific, and frequency dependent maximum attenuation. The reference characteristics for adjusting the background noise may be specified by the dominant speaker channel. In various embodiments, an automatic gain control (AGC) with a dynamic target level may ensure similar speech signal levels in all channels. Details are discussed below.

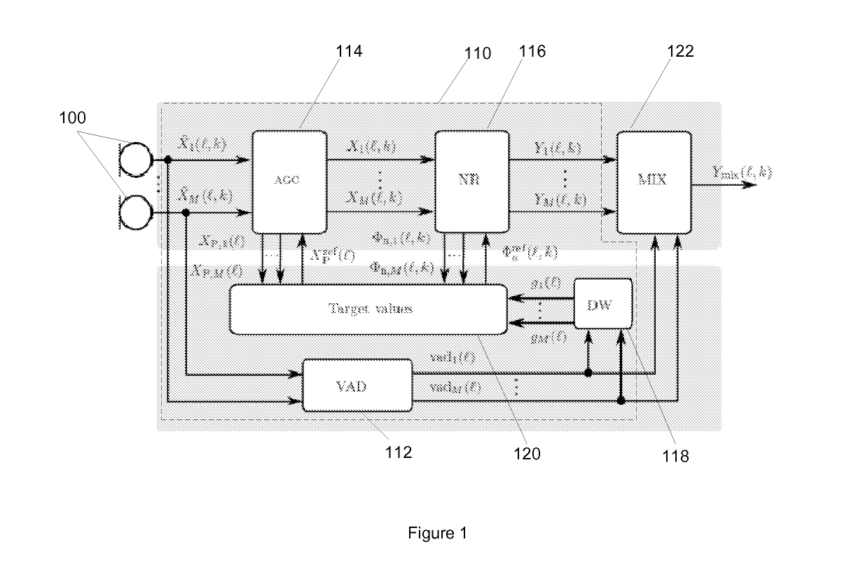

FIG. 1 shows a system overview of a signal processing system for dynamic mixing of signals, in accordance with an embodiment of the invention. Applications of the system may vary greatly, from live mixing scenarios over teleconferencing systems to hands free telephony in a car system. The system includes M microphones 100, with microphone index m, that are associated, without limitation, to M input signals The M input signals are combined to form one (or more) output signals Y.

Due to changing acoustic situations, including, but not limited to speaker changes, the microphone signal levels typically vary over time. Furthermore, various microphones 100 may be positioned, without limitation, in different speakers that are located apart from each other so as to have varying noise characteristics. For example, various speakers may be positioned in different passenger compartments of a vehicle, such as an automobile or boat, or at different locations for a conference call.

In illustrative embodiments, a preprocessing module 110 receives the signals from microphones 100, and dynamically filters each of the signals according to a noise reduction algorithm, creating preprocessed signals Y₁ to Y_{M} having substantially equivalent noise characteristics. The preprocessing module 110 may include, without limitation, a Voice Activity Detection (VAD) 112 that determines the dominance of each microphone and/or speaker, whereupon Dominance Weights (DW) are computed 118 that contribute to calculate target values 120 for adjusting the AGC 114 and the maximum attenuation of the NR 116. After these preprocessing steps the signals in each channel have been driven to similar sound level and noise characteristics, and are combined, for example, at mixer 122.

The processing may be done in the frequency domain or in subband domain where l denotes the frame index and k the frequency index. The short-time Fourier transform may use a Hann window and a block length of, without limitation, 256 samples with 75% overlap at a sampling frequency of 11025 Hz. Each microphone signal may be, for example, modeled by a superposition of a speech and a noise signal component:

\tilde{X}ₘ(l,k)=\tilde{S}ₘ(l,k)+Ñₘ(l,k). (1)

### Speaker Dominance

In accordance with various embodiments of the invention, when computing the target levels 120, it is often important to know which speaker/microphone is the dominant one at a time instance. Dominance weights (DW) 118 may be determined by evaluating the duration for which a speaker has been speaking. The DW 118 may be used later on to set the target values 120. If only one speaker is active the target values may be controlled by this concrete channel alone after a predetermined amount of time. If all speakers are active in a similar way the target values may correspond, without limitation, to the mean of all channel characteristics. A fast change of the DW could result in level jumps or modulations in the background noise. Therefore, a slow adaptation of these weights is recommended (e.g. realized by strong temporal smoothing).

To determine values for the necessary fullband VAD vadₘ(l) for each channel, various methods may be used, such as the one described in T. Matheja and M. Buck, “Robust Voice Activity Detection for Distributed Microphones by Modeling of Power Ratios,” in 9. ITG-Fachtagung Sprachkommunikation, Bochum, October 2010, which is hereby incorporated herein by reference in its entirety. For example, specific counters cₘ(l) may, without limitation, be increased for each time frame and each channel the specific speakers are active (vadₘ(l)=1), otherwise the counters are decreased or left unchanged:

$${c}_{m} ( l ) = \{ \begin{matrix}min \{ {c}_{m} ( l - 1 ) + {c}_{i n c} , {c}_{ma x} \} , if {vad}_{m} ( l ) = 1 , \\ max \{ {c}_{m} ( l - 1 ) - {c}_{dec , m} , {c}_{m i n} \} , if {vad}_{{m}^{′ }} ( l ) = 1 , {m}^{′} \neq m \\ {c}_{m} ( l - 1 ) , else .\end{matrix} \qquad ( 2 )$$

The limitations of the counters by cₘₐₓ or cₘᵢₙ respectively define full or minimal dominance of a speaker. In various embodiments, the increasing interval c_{inc} of the counters may be set in such a way that the current speaker is the dominant one after speaking t_{inc} seconds. With the update time T_{frame} between two consecutive time frames it follows:

$${c}_{inc} = \frac{{c}_{ma x} - {c}_{m i n}}{{t}_{inc}} \cdot {T}_{frame} . \qquad ( 3 )$$

The decreasing constant may be recomputed for a channel m if another speaker in any other channel m′ becomes active. In this embodiment, single-talk is assumed. In such embodiments, the dominance counter of the previous speaker may become cₘᵢₙ after the time the new active speaker reaches cₘₐₓ and therewith full dominance. Including a constant c with a very low value to avoid the division by zero, c_{dec,m} may be determined by

$${c}_{dec , m} = \frac{{c}_{m} ( l ) - {c}_{m i n}}{{c}_{ma x} - {c}_{{m}^{′}} ( l ) + ɛ} \cdot {c}_{inc} , if {vad}_{m} ( l ) = 0. \qquad ( 4 )$$

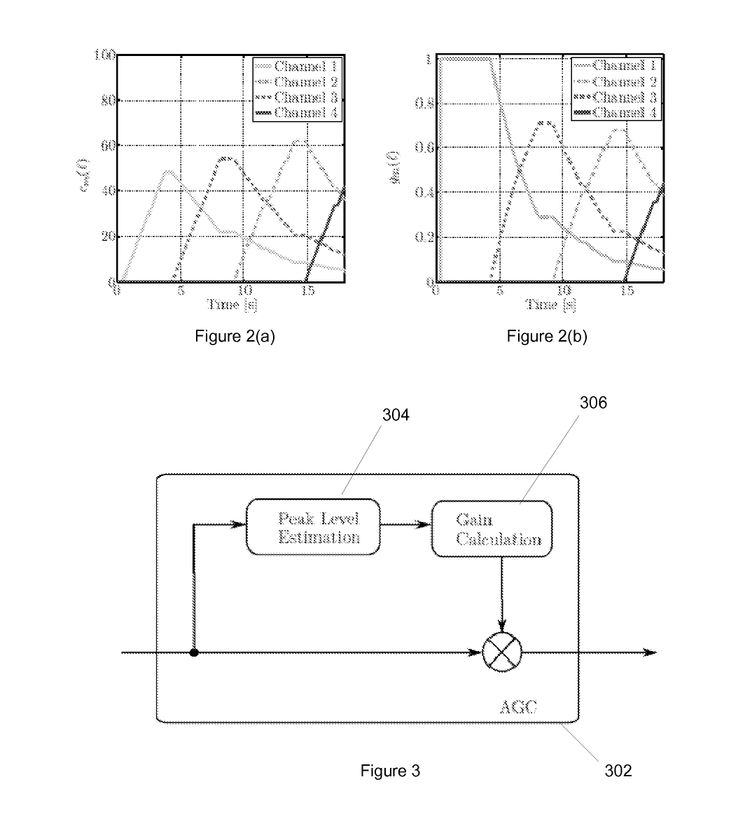

Illustratively, FIG. 2(a) shows exemplary counters (with cₘᵢₙ=0 and cₘₐₓ=100), which can be mapped, as shown in FIG. 2(b), to speaker dominance weights gₘ(l) that characterize the dominance of a speaker:

$${g}_{m} ( l ) = \frac{{c}_{m} ( l )}{{\sum }_{n = 1}^{M} {c}_{n} ( l )} . \qquad ( 5 )$$

### Dynamic Signal Adjustment

To compensate for the above-mentioned speech and/or noise level differences, an AGC 114 and a dynamic NR 116 are presented below that perform an adaptation to adaptive target levels computed out of the underlying microphone signals, in accordance with various embodiments of the invention.

### Automatic Gain Control

FIG. 3 shows a block diagram of an AGC, in accordance with an embodiment of the invention. In various embodiments of the invention, based on the input signal \tilde{X}ₘ(l,k), the AGC 302 may estimate, without limitation, the peak level \tilde{X}_{P,m}(k) in the m-th microphone signal 304 and determines a fullband amplification factor aₘ(l) 306 to adapt the estimated peak level to a target peak level X_{P}^{ref}(k).

An illustrative method for peak level estimation is proposed in E. Hansler and G. Schmidt, Acoustic Echo and Noise Control: A Practical Approach. Hoboken, N.J., USA: John Wiley & Sons, 2004, vol. 1, which is hereby incorporated herein by reference in its entirety. Instead of using the time domain signal for peak tracking, a root-mean-square measure may be applied over all subbands. The AGC 114 may be processed in each channel with frequency independent gain factors. Then the output results in

Xₘ(l,k)=aₘ(l)\tilde{X}ₘ(l,k), (6)

with the recursively averaged gain factors

$${a}_{m} ( l ) = γ \cdot {a}_{m} ( l ) + ( 1 - γ ) \cdot \frac{{X}_{P}^{ref} ( l )}{{X}_{P , m} ( l )} . \qquad ( 7 )$$

Here γ denotes the smoothing constant. The range of γ may be, without limitation, 0<γ<1. For example, γ may be set to 0.9. The target or rather reference peak level X_{P}^{ref}(l) is a weighted sum of all peak levels and is determined by

$${X}_{P}^{ref} ( l ) = {\sum }_{m = 1}^{M} {g}_{m} ( l ) \cdot {\hat{X}}_{P , m} ( l ) . \qquad ( 8 )$$

Thus, in illustrative embodiments of the invention, the reference speech level may be mainly specified by the dominant channel, and the different speech signal levels are adapted to approximately the same signal power.

### Dynamic Noise Reduction

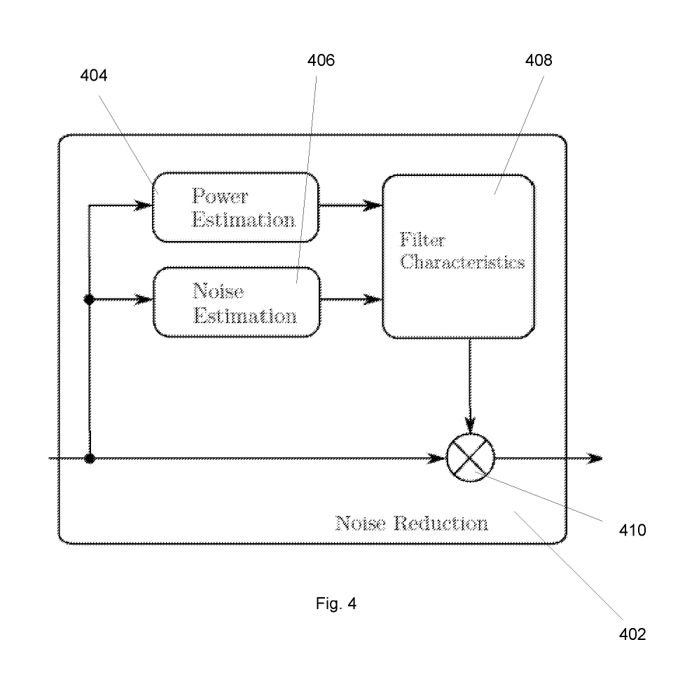

Illustratively, the dynamic NR 116 may aim for equal power and spectral shape of the background noise for all channels. FIG. 4 shows a block diagram of a NR 402, in accordance with an embodiment of the invention. The NR 402 may include both power and noise estimators 404 and 406, respectively, that determine filter characteristics 408 for filtering 410 the incoming signal. The maximum attenuation may be varied for each microphone and for each subband. With \tilde{Φ}_{n,m}(l,k) denoting the estimated noise power spectral density (PSD) in the m-th microphone channel, the noise PSDs after the AGC 114 result in

Φ_{n,m}(l,k)=aₘ²(l)\tilde{Φ}_{n,m}(l,k) (9)

For the NR 116, different characteristics may be chosen that are based on spectral weighting. For example, the NR filter coefficients \tilde{H}ₘ(l,k) may be calculated by a recursive Wiener characteristic (see E. Hansler et al.) with the fixed overestimation factor β, the maximum overestimation α and the overall signal PSD Φ_{x,m}(l,k) estimated by recursive smoothing:

$${\tilde{H}}_{m} ( l , m ) = 1 - min ( α , \frac{β}{{H}_{m} ( l - 1 , k )} ) \frac{{Φ}_{n , m} ( l , k )}{{Φ}_{x , m} ( l , k )} . \qquad ( 10 )$$

For realizing a maximum attenuation in each channel the filter coefficients may be limited by an individual dynamic spectral floor bₘ(l,k):

Hₘ(l,k)=max(\tilde{H}ₘ(l,k),bₘ(l,k)). (11)

After setting a reference floor b^{ref} specifying the overall noise reduction and after estimating a common target noise PSD Φₙ^{ref}(l,k) the spectral floors may be determined by

$${b}_{m} ( l , k ) = {b}^{ref} \cdot \sqrt{\frac{{Φ}_{n}^{ref} ( l , k )}{{Φ}_{n , m} ( l , k )}} . \qquad ( 12 )$$

Here the target noise PSD may be computed adaptively similar to the target peak level in Eq. 8 by the dominance weights:

$${Φ}_{n}^{ref} ( l , k ) = {\sum }_{m = 1}^{M} {g}_{m} ( l ) \cdot {Φ}_{n , m} ( l , k ) . \qquad ( 13 )$$

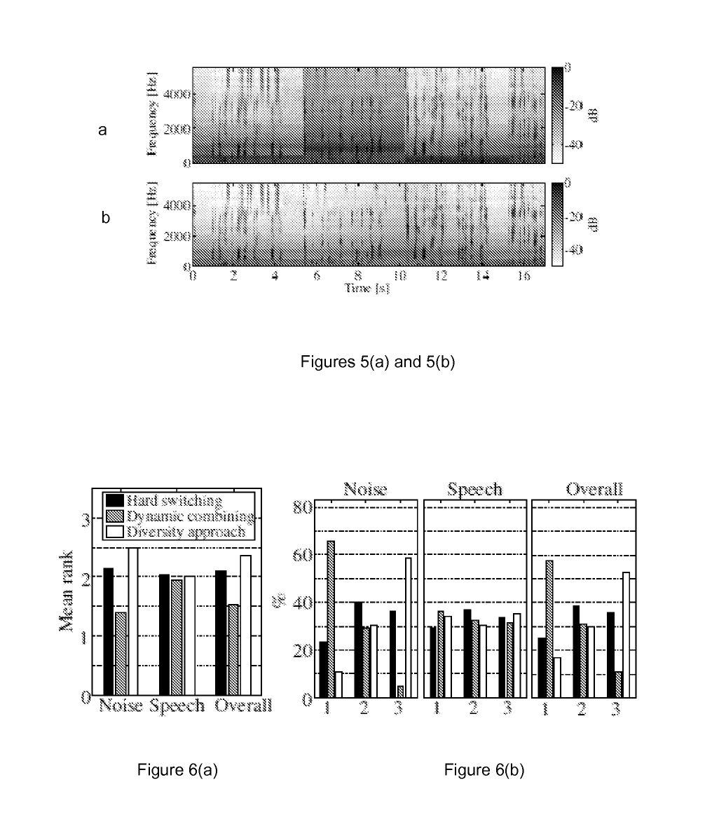

Differences in the noise levels and colorations over all channels may be, without limitation, compensated by the dynamic spectral floor bₘ(l,k). FIG. 5(a) shows the output signal after inter channel switching (no NR). FIG. 5(b) shows the spectrogram of the resulting processed signal with b^{ref}=0.4, in accordance with an embodiment of the invention. In various embodiments, it is not compulsory to do as much noise reduction as possible, but rather as much as desired to compensate for the mentioned different noise characteristics. Illustratively, for adequate performance of the NR 116 a limit may advantageously be introduced:

bₘ(l,k)ε[b^{min},b^{max}] with b^{min}≦b^{ref}≦b^{max}. (14)

If the AGC weights are in the range

$$\frac{{b}^{ref}}{{b}^{ma x }} \sqrt{\frac{{Φ}_{n}^{ref} ( l - 1 , k )}{{\tilde{Φ}}_{n , m} ( l , k )}} < {a}_{m} ( l ) < \frac{{b}^{ref}}{{b}^{m i n}} \sqrt{\frac{{Φ}^{ref} ( l - 1 , k )}{{\tilde{Φ}}_{n , m} ( l , k )}} . \qquad ( 15 )$$

the processing will typically work fine, otherwise residual switching effects may be audible. To obtain the processed signals, the filter coefficients from Eq. 11 may be applied to the complex-valued signal in the frequency domain:

Yₘ(l,k)=Hₘ(l,k)Xₘ(l,k). (16)

As a result, all signals are driven to show similar noise characteristics (for example, equivalent power and/or spectral shape) and a smooth transition period between the particular active speaker channels. Differences in the strength of the noise signals are tolerated but only may come to the fore after some time if, for example, only one speaker is the dominant one.

### Signal Combining

The processed signals are now combined at mixer 122 to get, without limitation, one output signal. In various embodiments, a plurality of outputs may be realized by any combination of the processed signals. Of course, the weights for combining the signals can be chosen independently from the dominance weights, and a variety of different methods may be applied. The mixer weights may be based, without limitation, on speech activity, using, for example, output from the VAD 112. Hard switching methods would apply real-valued weights with discrete values. Alternatively, the switching between channels may be realized more smoothly by soft weights which are increased and decreased with a certain speed depending on speech activity. More sophisticated mixing methods may use frequency dependent weights which are assigned dynamically depending on the input signals. Those methods may also include complex-valued weights to align the phases of the speech components of the input signals. In this case, the output signal may yield an improved SNR due to constructive superposition of the desired signal.

In accordance with various embodiments, for example, where single talk situations can be assumed where only one speaker is active at the same time, it may be appropriate to use real-valued fullband weights wₘ(l):

$${Y}_{m i x} ( l , k ) = {\sum }_{m = 1}^{M} {w}_{m} ( l ) {Y}_{m} ( l , k ) . \qquad ( 17 )$$

Due to the adjustment of the different signal characteristics in all the channels one can switch between the active speakers without noticing any switching effects (see FIG. 3). The weights wₘ(l)ε{0,1} may be determined by the VAD 112 and are held until another speaker becomes active. When using soft weights for mixing, the mixer weights wₘ(l) have to change fast. For example, an onset of a new (inactive up to now) speaker requires a fast increase in the corresponding weight (attack) in order not to miss much speech. The decay (release) is usually done more slowly because it is probable that the active speaker continues speaking.

Generally, any mixing methodology known in the art may be applied. For example, mixing methodologies that apply frequency depending weights (e.g., diversity techniques) or even complex-valued weights (e.g., such as SNR optimizing techniques), may be, without limitation, utilized.

### Computational Efficient Solution

In order to save computational effort, in various embodiments not all channels are processed completely. For example, noise reduction and/or AGC may be calculated only for the N most active channels. Illustratively, the channels with the highest mixer weights wₘ(l) could be taken (1≦N<M). The other channels are not processed and the corresponding mixer weights are set to zero. They don't contribute to the output signal at all. In the case that more than N speakers are active at the same time, there may be the problem that at least one speaker is not covered optimally. However, in a car environment the speech signal of this speaker may come over cross-coupling into the output signal of the mixer. Thus, he is not completely suppressed. In practical scenarios, this shouldn't happen often or permanently.

### Evaluation

The above-described system was evaluated with signals measured in cars driving at approximately 90 km/h and 130 km/h with four alternately speaking persons, two at the front seats and two at the rear seats, each having a dedicated microphone. Adverse noise scenarios with an open window were considered. A subjective listening test was performed where three signal combining methods were compared: Hard switching between the noise reduced channel signals with a fixed spectral floor b=1.4; the method for dynamic signal combining (b^{ref}=0.4, b^{min}=0.1, b^{max}=3), in accordance with various embodiments of the invention; and a diversity approach (see Freudenberger et al.). Ten test persons listened to 17 speech signal sets. In each set, one signal was processed by each of the three different methods. The challenge was to sort the resulting signals by their quality starting with the best (index 1) and ending with the worst (index 3). The subjects could listen to the signals as often as they liked. The speech quality, the sound of the noise and the overall impression were valued.

FIGS. 6(a-b) shows the results of the test. FIG. 6(a) shows the mean voting results. FIG. 6(b) shows the rating distribution for the different methods. The simple hard switching between the channels shows poor results which may come from annoying noise jumps. With the other methods a substantially constant background noise is achieved, but the method of dynamic signal combining, according to various embodiments of the invention, yields the best results. The speech quality has been rated similar in all three approaches. The diversity method showed an unnatural sounding background noise here because it is originally designed to achieve a good speech quality. For the overall impression also the background noise seems to be crucial. Thus, the approach according to the above-described embodiments of the invention, with its natural sound and smooth noise transitions is advantageous.

### CONCLUSION

A new system and method for dynamic signal combining supporting several speakers in noisy environments is presented. Two different sets of weights may be used which can be controlled independently: The mixer weights may vary very fast to capture speech onsets after a speaker change, whereas the dominance weights may be adjusted more slowly to specify the desired signal characteristics for the resulting signal. Thus, smooth transitions between the microphone signals of the different speakers can be achieved even if the background noise or the speech level differ strongly among the channels. The presented system and method also can be used as a preprocessor for other mixing approaches with soft or complex valued weights due to its full independence of these weights.

The present invention, for example, the preprocessing module 110 and/or the mixer 122 may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently, non-transitory or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.

The embodiments of the invention described above are intended to be merely exemplary; numerous variations and modifications will be apparent to those skilled in the art. All such variations and modifications are intended to be within the scope of the present invention as defined in any appended claims.

1-29. (canceled)

30. A method, comprising:
receiving a plurality of signals containing sound information;
performing, using at least in part a computer processor, dynamic noise reduction filtering on the plurality of signals to generate respective preprocessed signals having substantially equivalent noise characteristics; and
combining at least two of the preprocessed signals to provide an output signal.

31. The method according to claim 30, further comprising providing, by respective microphones, the plurality of signals, wherein at least two of the microphones are positioned in different locations in a vehicle.

32. The method according to claim 30, wherein performing the dynamic noise reduction filtering of the plurality of signals further includes driving the preprocessed signals such that background noise is substantially equivalent as to at least one of spectral shape and power.

33. The method according to claim 30, wherein the noise characteristics include a substantially equivalent signal to noise ratio.

34. The method according to claim 30, wherein signals in the plurality of signals are each associated with a respective channel, and wherein the dynamic noise reduction filtering includes determining a dynamic spectral floor for each of the channels based, at least in part, on a noise power spectral density.

35. The method according to claim 30, further comprising dynamically adjusting a signal level of each of the signals in generating the preprocessed signals.

36. The method according to claim 35, further including dynamically adjusting the signal level of each of the signals to a target level.

37. The method according to claim 35, further including:
associating each of the signals with a channel;
detecting voice activity and determining a dominance weight for each of the channels based on the detected voice activity; and
dynamically adjusting the signal level of each of the signals in creating the preprocessed signals based on the dominance weights for the channels.

38. The method according to claim 30, further including combining the at least two preprocessed signals which are weighted corresponding to channel speech activity.

39. A system comprising:
a preprocessing module to receive a plurality of signals, the preprocessing module including a dynamic noise reduction filtering module to generate preprocessed signals having substantially equivalent noise characteristics; and
a mixer for combining at least two of the preprocessed signals.

40. The system according to claim 39, further comprising a plurality of microphones to provide the plurality of signals, wherein at least two of the microphones are positioned in different locations of a vehicle.

41. The system according to claim 39, wherein the dynamic noise reduction filtering module is configured such that background noise of the preprocessed signals is substantially equivalent as to at least one of spectral shape and power.

42. The system according to claim 39, wherein the dynamic noise reduction filtering module is configured such that a signal to noise ratio of the preprocessed signals is substantially equivalent.

43. The system according to claim 39, wherein each of the signals is associated with a respective channel, and wherein the dynamic noise reduction filtering module is configured to utilize a dynamic spectral floor for each of the channels based, at least in part, on a noise power spectral density.

44. The system according to claim 39, wherein the preprocessing module further includes a gain control module to dynamically adjust a signal level of each of the signals.

45. The system according to claim 44, wherein the gain control module is configured to dynamically adjust the signal level of each of the signals to a target level.

46. The system according to claim 44, wherein each of the signals is associated with a respective channel, and wherein the preprocessing module further includes a voice activity detection module configured to determine a dominance weight for each of the channels, wherein the gain control module is configured to adjust the signal level of each of the signals based, at least in part, on the dominance weights of the channels.

47. The system according to claim 39, wherein the at least two of the preprocessor signals are weighted corresponding to channel speech activity.

48. An article, comprising:
at least one computer readable medium including non-transitory stored instructions that enable a machine to:
receive a plurality of signals containing sound information;
perform, using at least in part a computer processor, dynamic noise reduction filtering on the plurality of signals to generate respective preprocessed signals having substantially equivalent noise characteristics; and
combine at least two of the preprocessed signals to provide an output signal.

49. The article according to claim 48, further comprising instructions for driving the preprocessed signals such that background noise is substantially equivalent as to at least one of spectral shape and power.

50. The article according to claim 48, wherein the noise characteristics include a substantially equivalent signal to noise ratio.
